(19) United States
(12) Patent Application Publication
(10) Pub. No.: US 2026/0162595 A1
(43) Pub. Date: Jun. 11, 2026

(54) DISPLAY DEVICE

(71) Applicant: InnoLux Corporation, Miao-Li County (TW)

(72) Inventors: Hung-Kun CHEN, Miao-Li County (TW); Katsuhisa FUNAKOSHI, Miao-Li County (TW); Ting-Yao CHU, Miao-Li County (TW)

(21) Appl. No.: 19/384,201

(22) Filed: Nov. 10, 2025

(30) Foreign Application Priority Data
Dec. 9, 2024 (CN) 202411798142.7

(51) Int. Cl. G09G 3/32

(52) U.S. Cl. CPC G09G 3/32; G09G 2300/026; G09G 2300/043; G09G 2330/04

(57) ABSTRACT

A display device has a first area and a second area, and includes: a first driving unit and a first power source arranged in a first peripheral sub-area, a second driving unit and a second power source arranged in a second peripheral sub-area, a first signal line and a second signal line arranged in the first area and the second area; a first display unit arranged in a first display sub-area and connected to the first driving unit via the first signal line; a second display unit arranged in a second display sub-area and connected to the second driving unit via the second signal line, a first discharge unit connected between the first power source and the first signal line, and a second discharge unit connected between the second power source and the second signal line, wherein the first power source and the second power source are electrically separated.

### CROSS-REFERENCE TO RELATED APPLICATIONS

This application claims the benefits of the Chinese Patent Application Serial Number 2024117981427, filed on Dec. 9, 2024, the subject matter of which is incorporated herein by reference.

### BACKGROUND

### Field of the Disclosure

The present disclosure relates to a display device and, more particularly, to a seamless multi-screen display device.

### Description of Related Art

In the development of display devices, seamless multi-screen is to use independent display technologies to set up multiple display screens on a display device, for example, including a first screen and a second screen disposed on the left and right sides of the display device, respectively, wherein the first screen and the second screen may be driven by a first driving circuit and a second driving circuit respectively disposed on the left and right sides of the display device. With this driving architecture, a pixel of the display device will have two (left and right) gate lines from the first and second driving circuits passing through and extending to the other side.

In order to protect the display device from the influence of static electricity, an electrostatic discharge (ESD) element may be added to the gate line to discharge the undesirable static electricity so as not to damage the circuit elements of the display device. However, the existing electrostatic discharge element has no independent power supply and cannot provide protection when the display screen fails, which is thus not satisfactory.

Therefore, it is necessary to provide an improved display device to alleviate and/or obviate the aforementioned problems.

### SUMMARY

The present disclosure provides a display device having a first area and a second area connected to the first area, wherein the first area includes a first peripheral sub-area and a first display sub-area, and the second area includes a second peripheral sub-area and a second display sub-area. The display device includes: a first driving unit and a first power source disposed in the first peripheral sub-area; a second driving unit and a second power source disposed in the second peripheral sub-area; a first signal line disposed in the first area and the second area; a second signal line disposed in the first area and the second area; a first display unit disposed in the first display sub-area and electrically connected to the first driving unit via the first signal line; a second display unit disposed in the second display sub-area and electrically connected to the second driving unit via the second signal line; a first discharge unit electrically connected between the first power source and the first signal line; and a second discharge unit electrically connected between the second power source and the second signal line, wherein the first power source is electrically separated from the second power source.

The present disclosure further provides a display device having a first area and a second area connected to the first area, wherein the first area includes a first peripheral sub-area and a first display sub-area, and the second area includes a second peripheral sub-area and a second display sub-area. The display device includes: a first driving unit and a second power source disposed in the first peripheral sub-area; a second driving unit and a first power source disposed in the second peripheral sub-area; a first signal line disposed in the first area and the second area; a second signal line disposed in the first area and the second area; a first display unit disposed in the first display sub-area and electrically connected to the first driving unit via the first signal line; a second display unit disposed in the second display sub-area and electrically connected to the second driving unit via the second signal line; a first discharge unit electrically connected between the first power source and the first signal line; and a second discharge unit electrically connected between the second power source and the second signal line, wherein the first power source is electrically separated from the second power source.

Other novel features of the disclosure will become more apparent from the following detailed description when taken in conjunction with the accompanying drawings.

### BRIEF DESCRIPTION OF DRAWINGS

FIG. 1 is a schematic diagram showing the structure of a display device according to an embodiment of the present disclosure;

FIG. 2 is a schematic diagram showing the configuration of the first display sub-area and the second display sub-area of the display device of the present disclosure;

FIG. 3 is a schematic diagram showing the structure of a display device according to another embodiment of the present disclosure; and

FIG. 4 is a schematic diagram showing the structure of a display device according to another embodiment of the present disclosure.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers, such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “bove”, “ver”, “n”, “elow”, or “nder” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims such as “electrically connect” and “couple” are intended that an element may not only directly electrically connect to other element, but also indirectly electrically connect to other element.

In addition, in the specification and claims, the term “almost”, “about”, “approximately” or “substantially” usually means within 20%, 10%, 5%, 3%, 2%, 1% or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “ranging from the first value to the second value” and “range between the first value and the second value” indicate that the range includes the first value, the second value, and other values between the first value and the second value.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those skilled in the art, the background of the present disclosure or the context of the present specification, and should not be read by an ideal or over-formal way.

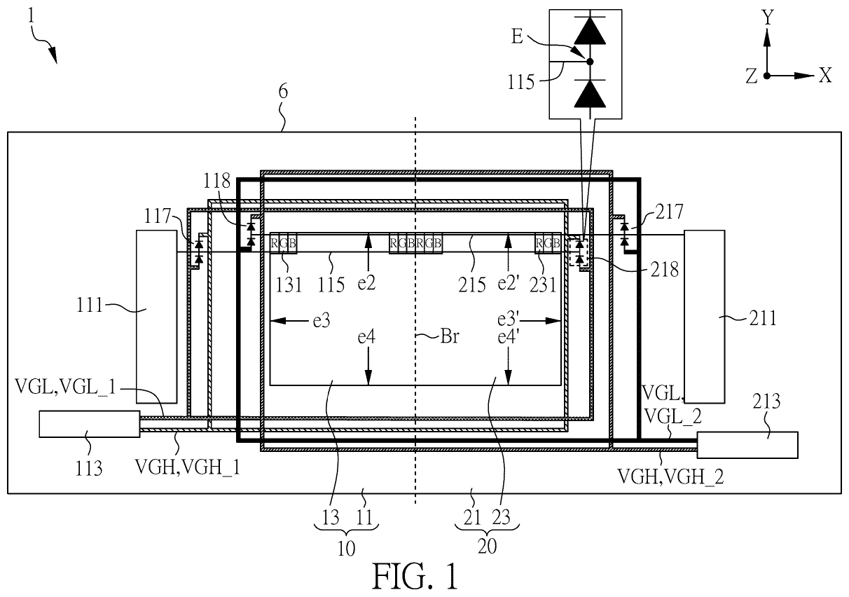

Please refer to FIG. 1, which is a schematic diagram showing the structure of a display device 1 according to an embodiment of the present disclosure, wherein the display device 1 is illustrated by a seamless multi-screen display device, which may be a self-luminous or non-self-luminous display device including active components (for example, transistors, diodes, integrated circuits, display pixels, etc.), passive components (for example, resistors, capacitors, inductors, oscillators, integrated components, etc.) and wires (scan lines, data lines), etc. In the top view direction (Z-axis direction), the display device 1 has a first area 10 and a second area 20 connected to the first area 10, wherein the first area 10 includes a first peripheral sub-area 11 and a first display sub-area 13, and the second area 20 includes a second peripheral sub-area 21 and a second display sub-area 23. The display device 1 includes a first driving unit 111, a second driving unit 211, a first power source 113, a second power source 213, a plurality of first signal lines 115, a plurality of second signal lines 215, a plurality of first display units 131, a plurality of second display units 231, a plurality of first discharge units 117, and a plurality of second discharge units 217.

As shown in FIG. 1, the first driving unit 111 and the first power source 113 are disposed in the first peripheral sub-area 11, the second driving unit 211 and the second power source 213 are disposed in the second peripheral sub-area 21, the first power source 113 and the second power source 213 may each be a battery, a power IC or a suitable power supply system, but not limited thereto, the first signal line 115 is disposed in the first area 10 and the second area 20, the second signal line 215 is disposed in the first area 10 and the second area 20, the first display unit 131 is disposed in the first display sub-area 13 and electrically connected to the first driving unit 111 via the first signal line 115, the second display unit 231 is disposed in the second display sub-area 23 and electrically connected to the second driving unit 211 via the second signal line 215, the first discharge unit 117 is electrically connected between the first power source 113 and the first signal line 115, and the second discharge unit 217 is electrically connected between the second power source 213 and the second signal line 215, wherein the first power source 113 and the second power source 213 are electrically separated.

The details of each component are described below, and please still refer to FIG. 1.

First, the first driving unit 111 and the second driving unit 211 are described. The first driving unit 111 and the second driving unit 211 may each be a driving circuit of the type of IC (Integrated Circuit), COF (Chip On Foil) or GOP (Gate On Panel), and may be used to provide driving signals, while it is not limited thereto. Although one side of the display device 1 shown in FIG. 1 only includes one driving unit (one first driving unit 111 or one second driving unit 211), in actual applications, one side of the display device 1 may include multiple driving units (multiple first driving units 111 or multiple second driving units 211), and the first driving unit 111 and the second driving unit 211 are respectively arranged in two peripheral sub-areas 11 and 21 of the display device 1. Specifically, the first driving unit 111 may be, for example, arranged in the first peripheral sub-area 11, and the second driving unit 211 may be, for example, arranged in the second peripheral sub-area 21. Furthermore, in one embodiment, the first driving unit 111 and the second driving unit 211 may be electrically separated, that is, the first driving unit 111 and the second driving unit 211 are not electrically connected to each other, but the present disclosure is not limited thereto.

Next, the first display unit 131 and the second display unit 231 are described. In one embodiment, the first display unit 131 may be driven by a first driving unit 111 disposed in the first peripheral sub-area 11, and the second display unit 231 may be driven by a second driving unit 211 disposed in the second peripheral sub-region 21. The first display unit 131 and the second display unit 231 may each be a sub-pixel, which may be, for example, a red sub-pixel (R), a green sub-pixel (G) or a blue sub-pixel (B), while it is not limited thereto. When the display device 1 is a non-self-luminous display device, each of the display units 131 and 231 may include a composite element, such as a semiconductor, a source/drain (S/D), and a pixel electrode, and the range thereof is a range surrounded by the data line and the scan line. When the display device 1 is a self-luminous display device, each of the display units 131 and 231 may include a cathode, an anode, and a light-emitting layer, and the range thereof is a cathode range in a top view.

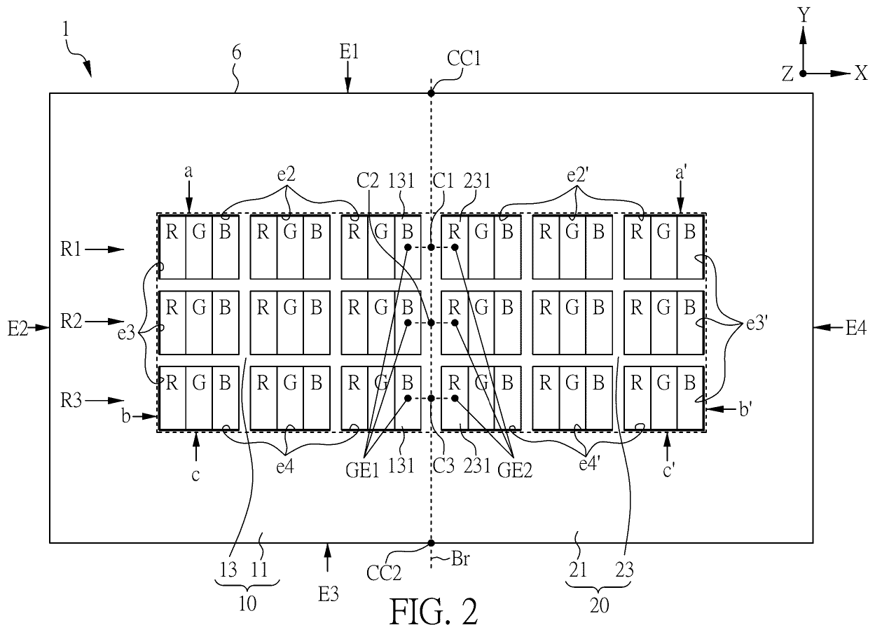

Next, the first area 10, the second area 20 and the boundary line Br of the display device 1 are described. Referring to FIG. 2, which is a schematic diagram showing the configuration of the first display sub-area 13 and the second display sub-area 23 of the display device 1 of the present disclosure, the display device 1 has first to fourth sides (E1˜E4), the first side E1 and the third side E3 are parallel to each other, the second side E2 and the fourth side E4 are parallel to each other, and the four sides E1 to E4 of the display device 1 may be, for example, edges of the substrate 6 of the display device 1, wherein the boundary line Br is a separation line between the first area 10 and the second area 20 of the display device 1. In detail, the display device 1 includes a plurality of display units 131, 231. In the X-axis direction, among the display units 131, 231 in the first row R1, the first display unit 131 closest to the second display unit 231 has a first geometric center GE1, and the second display unit 231 adjacent to the first display unit 131 has a second geometric center GE2. The first geometric center GE1 and the second geometric center GE2 have a first midpoint C1, and the second row R2 and the third row R3 may also obtain a second midpoint C2 and a third midpoint C3 in the same manner. In FIG. 2, the display sub-areas 13, 23 are illustrated as having three rows of display units 131, 231, but this is only for the convenience of explanation. In actual applications, the display sub-areas 13, 23 may have more rows of display units 131, 231, while the present disclosure is not limited thereto. The midpoint CC1 of the first side E1 of the display device 1, the first midpoint C1, the second midpoint C2, the third midpoint C3, and the midpoint CC3 of the third side E3 of the display device 1 are sequentially connected to define the boundary line Br, one side of the boundary line Br, such as the left side of FIG. 2, is the first area 10, and the other side of the boundary line Br, such as the right side of FIG. 2, is the second area 20. Next, the first display sub-area 13, the first peripheral sub-area 11, the second display sub-area 23 and the second peripheral sub-area 21 are described, with reference to FIG. 1 and FIG. 2, wherein the first display sub-area 13 is an area where the first display units 131 are provided, the second display sub-area 23 is an area where the second display units 231 are provided, and the first display sub-area 13 and the second display sub-area 23 are separated by a portion of the boundary line Br. The first display sub-area 13 has first to third boundaries a˜c, the first display sub-area 13 is surrounded by a portion of the boundary line Br and the boundaries a˜c, and a plurality of first display units 131 are provided in the first display sub-area 13, so that the first display sub-area 13 represents a complete light-emitting area. Similarly, the second display sub-area 23 has first to third boundaries a′˜c′, the second display sub-area 23 is surrounded by a portion of the boundary line Br and the boundaries a′˜c′, and a plurality of second display units 231 are provided in the second display sub-area 23, so that the second display sub-area 23 also represents a complete light-emitting area. Furthermore, referring to FIG. 2, the edges (e2, e3, e4) of the plurality of sub-pixels disposed at the edge of the first display sub-area 13 are connected to each other, so that the first to third boundaries (a, b, c) of the first display sub-area 13 and the first peripheral sub-area 11 may be defined. Specifically, the plurality of edges e2 may be connected to each other to form a boundary a, the boundary a may be further extended until it intersects with the boundary line Br, the plurality of edges e3 may be connected to each other to form a boundary b, the plurality of edges e4 may be connected to each other to form a boundary c, and the boundary c may be further extended until it intersects with the boundary line Br. Similarly, the edges (e2′, e3′, e4′) of the sub-pixels arranged at the edge of the second display sub-area 23 define the fourth to sixth boundaries (a′, b′, c′) between the second display sub-area 23 and the second peripheral sub-area 21. In detail, a plurality of edges e2′ may be connected to each other to form boundary a′, the boundary a′ may be further extended until it intersects with the boundary line Br, a plurality of edges e3′ may be connected to each other to form a boundary b′, a plurality of edges e4′ may be connected to each other to form a boundary c′, and the boundary c′ may be further extended until it intersects with the boundary line Br. The first side E1 of the display device 1 may be, for example, an edge adjacent to a boundary a of the first display sub-area 13 and a boundary a′ of the second display sub-area 23, the third side E3 may be, for example, an edge adjacent to a boundary c of the first display sub-area 13 and a boundary c′ of the second display sub-area 23, the second side E2 may be, for example, an edge adjacent to a boundary b of the first display sub-area 13, and the fourth side E4 may be, for example, an edge adjacent to a boundary b′ of the second display sub-area 23. Accordingly, taking this embodiment as an example (as shown in the figure), the range of the first display sub-area 13 is a range surrounded by the first boundary a, the second boundary b, the third boundary c, and a portion of the boundary line Br, and the range of the second display sub-area 23 is a range surrounded by the fourth boundary a′, the fifth boundary b′, the sixth boundary c′, and a portion of the boundary line Br, but this is only an example, and the present disclosure is not limited thereto.

Furthermore, since the first display unit 131 and the second display unit 231 are driven respectively by the first driving unit 111 and the second driving unit 211 to display patterns, the two display sub-areas 13 and 23 may be driven respectively by different driving signals, but display the same frame at the same time. Moreover, the first discharge unit 117 and the second discharge unit 217 for providing electrostatic protection respectively for the first display sub-area 13 and the second display sub-area 23 are respectively electrically connected to the electrically separated first power source 113 and second power source 213. Therefore, the two display sub-areas 13 and 23 may be protected respectively by two electrically separated electrostatic protection systems.

Next, the first peripheral sub-area 11 and the second peripheral sub-area 21 are described. In one embodiment, the first peripheral sub-area 11 is a portion of the first area 10 excluding the first display sub-area 13, and the first peripheral sub-area 11 surrounds the first display sub-area 13; the second peripheral sub-area 21 is a portion of the second area 20 excluding the second display sub-area 23, and the second peripheral sub-area 21 surrounds the second display sub-area 23, wherein the boundary between the first peripheral sub-area 11 and the second peripheral sub-area 21 is an extension of the boundary between the first display sub-area 13 and the second display sub-area 23.

Next, the first power source 113 and the second power source 213 are described. In one embodiment, the first power source 113 and the second power source 213 are respectively disposed in the first peripheral sub-area 11 and the second peripheral sub-area 21 to respectively provide voltages VGH and VGL to the first discharge unit 117 and the second discharge unit 217. More specifically, the first power source 113 provides a first high voltage VGH_1 and a first low voltage VGL_1 to the first discharge unit 117, and the second power source 213 provides a second high voltage VGH_2 and a second low voltage VGL_2 to the second discharge unit 217. The first power source 113 and the second power source 213 may each be a battery, a power IC or a suitable power supply system, while it is not limited thereto. In addition, the power sources 113 and 213 are electrically separated from the driving units 111 and 211, that is, the power sources 113 and 213 and the driving units 111 and 211 are not electrically conductive to each other.

Next, the first signal line 115 and the second signal line 215 are described. In one embodiment, the signal lines 115 and 215 are used to electrically connect the driving units 111 and 211 and the display units 131 and 231 so that, for example, the scanning signals of the driving units 111 and 211 may be transmitted to the display units 131 and 231. Specifically, the first signal line 115 is connected to the first driving unit 111, extends along the X-axis direction toward the second area 20 to the second peripheral sub-area 21 and is electrically connected to the first display unit 131, and may be selectively not electrically connected to the second display unit 231. The second signal line 215 is connected to the second driving unit 211, extends along the X-axis direction toward the first area 10 to the first peripheral sub-area 11 and is electrically connected to the second display unit 231, and may be selectively not electrically connected to the first display unit 131. Furthermore, in one embodiment, the first signal line 115 extends from the first driving unit 111 to the area between the second driving unit 211 and the second display unit 231, and the second signal line 215 extends from the second driving unit 211 to the area between the first driving unit 111 and the first display unit 131.

Next, the first discharge unit 117 and the second discharge unit 217 are described. The first discharge unit 117 and the second discharge unit 217 may each be a device with anti-static or grounding functions, such as a diode, a transistor, a floating gate transistor, a stacked transistor, or suitable material structures, etc., while it is not limited thereto. In the present embodiment, the first discharge unit 117 and the second discharge unit 217 are each exemplified as a diode element formed by two diodes connected in series, wherein, in the first discharge unit 117, the anode of the diode element is electrically connected to the first low voltage VGL_1 of the first power source 113, the cathode of the diode element is electrically connected to the first high voltage VGH_1 of the first power source 113, and connection point of the two diodes of the diode element is electrically connected to the first signal line 115. In the second discharge unit 217, the anode of the diode element is electrically connected to the second low voltage VGL_2 of the second power source 213, the cathode of the diode element is electrically connected to the second high voltage VGH_2 of the second power source 213, and the connection point of the two diodes of the diode element is electrically connected to the second signal line 215. Since the first discharge unit 117 and the second discharge unit 217 are electrically connected to different signal lines (that is, the first signal line 115 and the second signal line 215), and are electrically connected to different power sources (that is, the first power source 113 and the second power source 213), the first discharge unit 117 and the second discharge unit 217 may protect different signal lines and be electrically separated from each other. In addition, in one embodiment, in the top view direction (Z-axis direction), the first discharge unit 117 may be disposed between the first display unit 131 and the first driving unit 111, and the second discharge unit 217 may be disposed between the second display unit 231 and the second driving unit 211.

With the display device 1 described above, since the power source of the first discharge unit 117 disposed at the starting end of the first signal line 115 is provided by the first power source 113 (the first high voltage VGH_1 and the first low voltage VGL_1) disposed in the first area 10, when the display of the second area 20 fails, the first discharge unit 117 may still receive the voltage from the first power source 113 and operate normally to maintain the anti-static function, thereby reducing the risk of the first display unit 131 being damaged by static electricity. Similarly, since the power source of the second discharge unit 217 disposed at the starting end of the second signal line 215 is provided by the second power source 213 (the second high voltage VGH_2 and the second low voltage VGL_2) disposed in the second area 20, when the display of the first area 10 fails, the second discharge unit 217 may still receive the voltage from the second power source 113 and operate normally to maintain the anti-static function, thereby reducing the risk of the second display unit 231 being damaged by static electricity.

Furthermore, as shown in FIG. 1, the display device 1 of this embodiment may further include a third discharge unit 218 and a fourth discharge unit 118. The third discharge unit 218 is electrically connected between the first power source 113 and the first signal line 115. The fourth discharge unit 118 is electrically connected between the second power source 213 and the second signal line 215. The third discharge unit 218 and the fourth discharge unit 118 may each be a diode element formed by two diodes connected in series. In the third discharge unit 218, the anode of the diode element is electrically connected to the first signal line 115, the cathode of the diode element is electrically connected to a first high voltage VGH_1 of the first power source 113, and the connection point of the two diodes of the diode element is electrically connected to the first signal line 115. In the fourth discharge unit 118, the anode of the diode element is electrically connected to a second low voltage VGL_2 of the second power source 213, the cathode of the diode element is electrically connected to a second high voltage VGH_2 of the second power source 213, and the connection point of the two diodes of the diode element is electrically connected to the second signal line 215. In addition, in the top view direction (Z-axis direction), the third discharge unit 218 is disposed between the second display unit 231 and the second driving unit 211, and the fourth discharge unit 118 is disposed between the first display unit 131 and the first driving unit 111. In this embodiment, by connecting a diode element as an electrostatic discharge protection element to the end of the signal line 115 or 215, the risk of electrostatic discharge may be further avoided. For the first signal line 115, the end refers to an end away from the first driving unit 111 (labeled as E in the figure). Similarly, for the second signal line, the end refers to an end away from the second driving unit 211. Furthermore, since the power source of the third discharge unit 218 at the end of the first signal line 115 is provided by the first power source 113 disposed in the first area 10, when the display of the second area 20 fails, the third discharge unit 118 may still receive the voltage from the first power source 113 and operate normally to maintain the anti-static function, thereby reducing the risk of the first display unit 131 being damaged by static electricity. Similarly, since the power source of the fourth discharge unit 118 at the end of the second signal line 215 is provided by the second power source 213 disposed in the second area 20, when the display of the first area 10 fails, the fourth discharge unit 118 may still receive the voltage from the second power source 113 and operate normally to maintain the anti-static function, thereby reducing the risk of the second display unit 231 being damaged by static electricity.

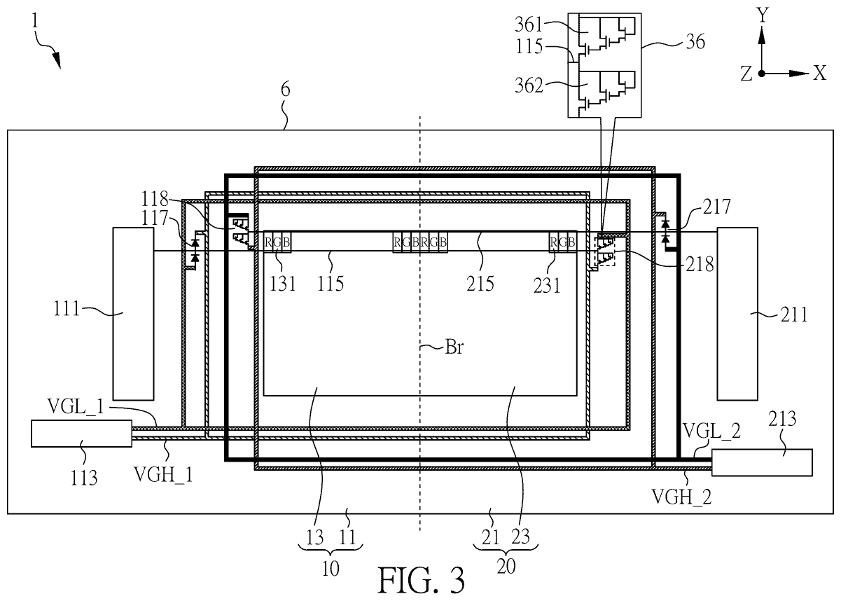

FIG. 3 is a schematic diagram showing the structure of a display device 1 according to another embodiment of the present disclosure. The display device 1 of this embodiment is similar to the display device 1 shown in FIG. 1, except that the third discharge unit 218 and the fourth discharge unit 118 are each a stacked transistor element 36 formed by two stacked transistors 361 and 362 connected in series. Each of the stacked transistors 361 and 362 is formed by stacking a plurality of transistors and is equivalent to a diode. In the third discharge unit 218, the anode of the diode equivalent from the stacked transistor element 36 is electrically connected to the first low voltage VGL_1 of the first power source 113, the cathode of the diode equivalent from the stacked transistor element 36 is electrically connected to the first high voltage VGH_1 of the first power source 113, and the connection between one stacked transistor 361 and another stacked transistor 362 in the stacked transistor element 36 is electrically connected to the first signal line 115. In the fourth discharge unit 118, the anode of the diode equivalent from the stacked transistor element 36 is electrically connected to the second low voltage VGL_2 of the second power source 213, the cathode of the diode equivalent from the stacked transistor element 36 is electrically connected to the second high voltage VGH_2 of the second power source 213, and the connection between one stacked transistor 361 and another stacked transistor 362 in the stacked transistor element 36 is electrically connected to the second signal line 215. In this embodiment, by connecting a stacked transistor element 36 as an electrostatic discharge protection element at the end of the signal line 115 or 215, the risk of electrostatic discharge may be further avoided. In addition, the description of other structures and operations of the display device 1 of this embodiment can be obtained by referring to the embodiment of FIG. 1, and thus a detailed description is deemed unnecessary.

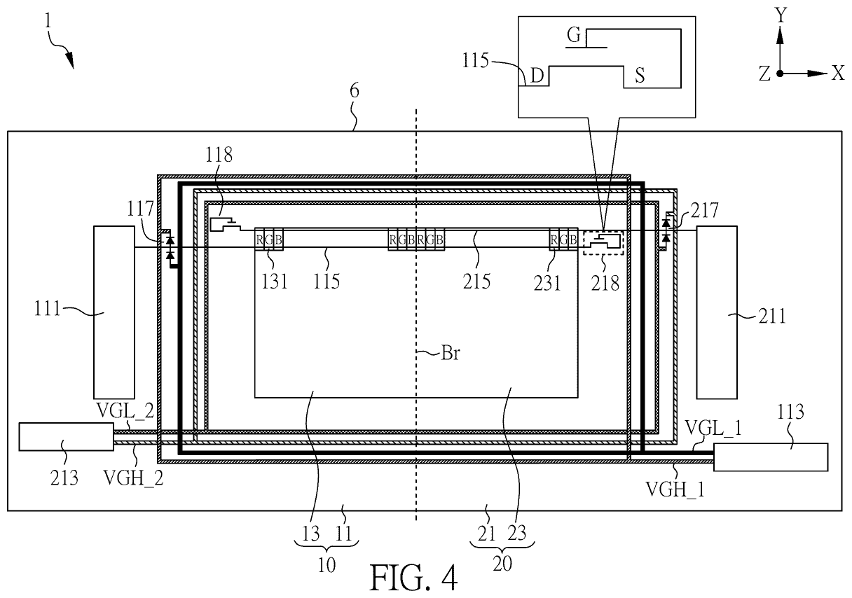

FIG. 4 is a schematic diagram showing the structure of a display device 1 according to another embodiment of the present disclosure, wherein most features of the embodiment of FIG. 4 are applicable to the description of the embodiment of FIG. 1, and thus the following description will focus on the differences.

Different from the embodiment of FIG. 1, in the display device 1 of this embodiment, the first driving unit 111 and the second power source 213 are arranged in the first peripheral sub-area 11, the second driving unit 211 and the first power source 113 are arranged in the second peripheral sub-area 21, the third discharge unit 218 and the fourth discharge unit 118 are each a floating transistor, the third discharge unit 218 is electrically connected to the first signal line 115, and the fourth discharge unit 118 is electrically connected to the second signal line 215. In the display device 1 of this embodiment, based on the difference between the second power source 213 being disposed in the first peripheral sub-area 11 and the first power source 113 being disposed in the second peripheral sub-area 21, the power source of the first discharge unit 117 disposed at the starting end of the first signal line 115 is provided by the first power source 113 (the first high voltage VGH_1 and the first low voltage VGL_1) disposed in the second area 20 (the second peripheral sub-area 21). Therefore, when the display of the first area 10 fails, the first discharge unit 117 may still receive the voltage from the first power source 113 and operate normally to maintain the anti-static function, thereby reducing the risk of the first display unit 131 being damaged by static electricity. Similarly, since the power source of the second discharge unit 217 disposed at the starting end of the second signal line 215 is provided by the second power source 213 (the second high voltage VGH_2 and the second low voltage VGL_2) disposed in the first area 10, when the display of the second area 20 fails, the second discharge unit 217 may still receive the voltage from the second power source 113 and operate normally to maintain the anti-static function, thereby reducing the risk of the second display unit 231 being damaged by static electricity. In addition, the description of other structures and operations of the display device 1 of this embodiment may be obtained by referring to the embodiment of FIG. 1, and thus it is not repeated here.

Furthermore, as shown in FIG. 4, the aforementioned floating transistor (third discharge unit 218, fourth discharge unit 118) may be a transistor having a gate G connected to a source S (to become floating) and a drain D connected to the signal lines 115 and 215. In addition, in the top view direction (Z-axis direction), the third discharge unit 218 is disposed between the second display unit 231 and the second driving unit 211, and the fourth discharge unit 118 is disposed between the first display unit 131 and the first driving unit 111. In this embodiment, by connecting a thin film transistor element with a floating gate to each of the end of the first signal line 115 and the end of the second signal line 215, the end of the first signal line 115 and the end of the second signal line 215 will not be left unconnected, thereby further avoiding the risk of electrostatic discharge. In addition, the description of other structures and operations of the display device 1 of this embodiment may be obtained by referring to the embodiment of FIG. 1, and thus a detailed description is deemed unnecessary.

It can be seen from the above description that, since the display device of the present disclosure has two electrically separated independent power sources, and the first discharge unit and the second discharge unit for providing electrostatic protection to the first display sub-area and the second display sub-area on opposite sides of the display device are respectively electrically connected to the two electrically separated independent power sources, the two display sub-areas may be respectively protected by two electrically separated electrostatic protection systems, so that, in the electrostatic discharge protection of the seamless multi-screen display technology, when the display of the display sub-area on one side fails, the independent power source on the same side or the other side may be used to output power so that the electrostatic protection system may still provide normal protection, thereby effectively protecting the display unit of the display device from being damaged by static electricity.

In one embodiment, it may determine whether a product in contention falls within the protection scope of the present disclosure at least by the presence or absence of components, component configurations and/or operating modes of the product in contention, or by the algorithm of the product in contention, while it is not limited thereto.

The features of the various embodiments of the present disclosure may be mixed and matched as desired as long as they do not violate the spirit of the invention or conflict with each other.

The aforementioned specific embodiments should be construed as merely illustrative, and not limiting the rest of the present disclosure in any way.

1. A display device having a first area and a second area connected to the first area, wherein the first area includes a first peripheral sub-area and a first display sub-area, and the second area includes a second peripheral sub-area and a second display sub-area, the display device comprising:
a first driving unit and a first power source disposed in the first peripheral sub-area;
a second driving unit and a second power source disposed in the second peripheral sub-area;
a first signal line disposed in the first area and the second area;
a second signal line disposed in the first area and the second area;
a first display unit disposed in the first display sub-area and electrically connected to the first driving unit via the first signal line;
a second display unit disposed in the second display sub-area and electrically connected to the second driving unit via the second signal line;
a first discharge unit electrically connected between the first power source and the first signal line; and
a second discharge unit electrically connected between the second power source and the second signal line,
wherein the first power source is electrically separated from the second power source.

2. The display device as claimed in claim 1, wherein the first driving unit and the second driving unit are electrically separated.

3. The display device as claimed in claim 1, wherein, in a top view direction, the first discharge unit is disposed between the first display unit and the first driving unit, and the second discharge unit is disposed between the second display unit and the second driving unit.

4. The display device as claimed in claim 1, further comprising a third discharge unit electrically connected between the first power source and the first signal line.

5. The display device as claimed in claim 4, wherein the first discharge unit is a diode element, and the third discharge unit is a stacked transistor element.

6. The display device as claimed in claim 5, wherein, in a top view direction, the third discharge unit is disposed between the second display unit and the second driving unit.

7. The display device as claimed in claim 5, further comprising a fourth discharge unit electrically connected between the second power source and the second signal line.

8. The display device as claimed in claim 7, wherein, in a top view direction, the fourth discharge unit is disposed between the first display unit and the first driving unit.

9. The display device as claimed in claim 1, wherein the first signal line extends from the first driving unit to an area between the second driving unit and the second display unit, and the second signal line extends from the second driving unit to an area between the first driving unit and the first display unit.

10. The display device as claimed in claim 1, wherein, the first peripheral sub-area 11 surrounds the first display sub-area 13, the second peripheral sub-area 21 surrounds the second display sub-area 23, a boundary between the first peripheral sub-area 11 and the second peripheral sub-area 21 is an extension of a boundary between the first display sub-area 13 and the second display sub-area 23.

11. The display device as claimed in claim 5, wherein the diode element is formed by two diodes connected in series, the stacked transistor element is formed by two stacked transistors connected in series, and each stacked transistor is formed by stacking a plurality of transistors.

12. A display device having a first area and a second area connected to the first area, wherein the first area includes a first peripheral sub-area and a first display sub-area, and the second area includes a second peripheral sub-area and a second display sub-area, the display device comprising:
a first driving unit and a second power source disposed in the first peripheral sub-area;
a second driving unit and a first power source disposed in the second peripheral sub-area;
a first signal line disposed in the first area and the second area;
a second signal line disposed in the first area and the second area;
a first display unit disposed in the first display sub-area and electrically connected to the first driving unit via the first signal line;
a second display unit disposed in the second display sub-area and electrically connected to the second driving unit via the second signal line;
a first discharge unit electrically connected between the first power source and the first signal line; and
a second discharge unit electrically connected between the second power source and the second signal line,
wherein the first power source is electrically separated from the second power source.

13. The display device as claimed in claim 12, wherein the first driving unit and the second driving unit are electrically separated.

14. The display device as claimed in claim 12, wherein, in a top view direction, the first discharge unit is disposed between the first display unit and the first driving unit, and the second discharge unit is disposed between the second display unit and the second driving unit.

15. The display device as claimed in claim 12, further comprising a third discharge unit electrically connected to the first signal line, wherein the first discharge unit is a diode element, and the third discharge unit is a floating transistor.

16. The display device as claimed in claim 15, wherein, in a top view direction, the third discharge unit is disposed between the second display unit and the second driving unit.

17. The display device as claimed in claim 12, further comprising a fourth discharge unit electrically connected to the second signal line, wherein the second discharge unit is a diode element and the fourth discharge unit is a floating transistor.

18. The display device as claimed in claim 17, wherein, in a top view direction, the fourth discharge unit is disposed between the first display unit and the first driving unit.

19. The display device as claimed in claim 12, wherein the first signal line extends from the first driving unit to an area between the second driving unit and the second display unit, and the second signal line extends from the second driving unit to an area between the first driving unit and the first display unit.

20. The display device as claimed in claim 12, wherein the first peripheral sub-area surrounds the first display sub-area, the second peripheral sub-area surrounds the second display sub-area, a boundary between the first peripheral sub-area and the second peripheral sub-area is an extension of a boundary between the first display sub-area and the second display sub-area.
